(19) United States
(12) Patent Application Publication
(10) Pub. No.: US 2009/0022351 A1
(43) Pub. Date: Jan. 22, 2009

(54) TOOTH-MAGNET MICROPHONE FOR HIGH NOISE ENVIRONMENTS

(76) Inventors: Chris M. Wieland, Loveland, CO (US); Mark E. Yager, Boulder, CO (US)

Correspondence Address: DUFT BORNSEN & FISHMAN, LLP, 1526 SPRUCE STREET, SUITE 302, BOULDER, CO, 80302, US

(21) Appl. No.: 11/780,998

(22) Filed: Jul. 20, 2007

(51) Int. Cl. H04R 11/04

(52) U.S. Cl. 381/364

(57) ABSTRACT

A microphone structure and method of operation that senses a user's speech as represented by vibrations of the jaw sensed by an electrically passive component mounted on a user's tooth. A permanent magnet is attached to the user's tooth and vibrates as the user's tooth and jaw vibrate in response to the user's speech (or other sounds). A coil senses changes in the magnetic flux in proportion to the vibration of the magnet and thus senses the user's speech. No wired connection is required to sense the vibrations of the tooth/jaw as compared to prior techniques and no electrical power is required within the user's mouth as compared to prior techniques.

### GOVERNMENT LICENSE

The U.S. Government has a paid-up license in this invention and the right in limited circumstances to require the patent owner to license others on reasonable terms as provided for by the terms of contract N00014-05-C-0034 awarded by the United States Navy.

### BACKGROUND

1. Field of the Invention

This invention relates generally to the detection and amplification of human vocal sounds such as speech and more specifically relates to detection and amplification of speech in high noise environments by means of monitoring the vibrations in the jaw and teeth.

2. Discussion of Related Art

Normal human speech produces two physical characteristics needed for vocal communications. The first is auditory vibrations that travel as waves through the air to nearby listeners. The second is internal vibrations of the tissue and bone of the speaker associated with human sound production. These internal vibrations are used by the speaker's ears and brain as a feedback mechanism allowing the speaker to “hear” the produced speech sounds as the vibrations of the skull. These vibrations of the skull and related bone and tissue structures during speech are perceived by the speaker's eardrum (in addition to the auditory waves carried through the air). Without this feedback mechanism, human speakers have difficulty producing “normal” sounding speech.

The vibrations induced in the skull, including the jaw, have been used as a means of monitoring and reproducing a speaker's vocalization in environments where the airborne auditory waves of the speaker are in competition with, or are exceeded by loud ambient sounds around the speaker. In such instances, it becomes difficult or impossible for even a nearby listener to understand or hear the speaker due to other loud noise sources drowning out the sounds of the speaker. In like manner, traditional microphones that rely on sensing the airborne auditory waves may be useless to sense the speaker's sounds as distinguished from the loud ambient noise.

A common configuration of a microphone adapted to sense vibrations emanating from speech of a person entails placing a sensitive linear accelerometer in close contact with the skin of the speaker at a location that is in close proximity to underlying bone that is vibrating as a result of speech. The vibrations of the skull, as perceived in the vibration of the accelerometer, are electronically amplified, filtered, and produce signals analogous to those recorded by standard air-conducting microphones. These “bone-conducting” microphones greatly reduce the influence of external, ambient noise impinging upon the microphone sensing of the speaker. These bone conduction microphones can therefore permit a speaker's voice to be sensed in the presence of relatively loud environmental noise.

In unusually loud work environment applications including, for example, personnel working around jet aircraft engines, the external air-conducted sound vibrations (ambient noise) can become so intense that they also cause vibrations of the speaker's head. These skull and tissue vibrations are then also perceived by the bone-conducting microphones and degrade the quality of the speech recorded from the speaker.

A simple method to decrease the influence of external, ambient noise in causing vibrations of the head is to wear a hard protective helmet. This can reduce the noise level reaching the wearer's head by over 40 dBA at frequencies most associated with speech (around 200 to 4000 Hz).

For cases where external noise may exceed 150 dBA, as with jet aircraft engines, additional means are needed to reduce the influence of external sounds when using bone vibrations to monitor speech. One approach that may reduce this noise effect is to monitor the vibrations of the speaker's skull, jaw, or teeth in a more direct fashion where the external tissue is bypassed. Directly, or indirectly, monitoring the vibrations induced in the teeth or jaw may improve the functionality of the bone-conducting microphone technique. For example, it is generally known to attach accelerometers to the teeth of a speaker to help increase the signal-to-noise ratio such that speech can be understood in sound fields approaching 160 dBA. Such direct attachment of an accelerometer to the tooth bypasses the tissue that limits the effectiveness of standard bone-conducting microphones.

Present techniques with a component inside the mouth present a problem in that the component within the mouth includes active electronics and thus requires electrical power. A wired approach requires a user to speak while wires protrude from their mouth. The wires may provide both electrical power and data signal exchange to extend the signals representing the sensed speech out of the mouth. A wireless approach may be employed but typically requires the wearer to also have a power source (such as batteries) and a transmitter (such as an RF signal generating unit) mounted somewhere within the mouth. In such a wireless approach, the additional components in the mouth may be large and cumbersome. In addition, placing a battery or other power source within the mouth may present health issues should the battery leak or fail in various ways.

It is evident from the above discussion that a need exists for an improved microphone device that is useful in high noise environments and does not present health issues by requiring electrical power within the user's mouth.

### SUMMARY

The present invention solves the above and other problems by providing a microphone structure that senses vibrations within the mouth using a tooth mounted device that requires no electrical power. More specifically, features and aspects hereof provide for mounting a permanent magnet on a tooth in the user's mouth. A pickup coil positioned external to the mouth senses magnetic flux changes caused by vibrations of the tooth/jaw of the user in proportion to the user's speech. Thus no electrical power is required within the mouth of the user to sense vibrations of the user's tooth/jaw for purposes of sensing the user's speech.

One aspect hereof provides a microphone that includes a permanent magnet attached to a user's tooth wherein the permanent magnet vibrates with the tooth to which it is attached. The microphone also includes a coil positioned external to the user's mouth and proximate the permanent magnet wherein the coil is configured to convert changes of magnetic flux produced by vibrations of the permanent magnet into electrical signals representing sounds produced by the user.

Another aspect hereof provides a method for sensing sounds generated by a speaker. The method provides for attaching a permanent magnet to a tooth of the speaker wherein the permanent magnet is attached so as to vibrate with the speaker's tooth in response to sounds generated by the speaker. The method also provides for positioning a coil external to the speaker's mouth and proximate the permanent magnet. The method then senses electrical signals generated by the coil responsive to changes in magnetic flux generated by vibrations of the permanent magnet such that the sensed electrical signals are representative of the sounds produced by the speaker.

### BRIEF DESCRIPTION OF THE DRAWINGS

FIG. 1 is a diagram representing an exemplary embodiment of a tooth magnet microphone in accordance with features and aspects hereof.

FIG. 2 is a diagram providing two views of exemplary positioning of a permanent magnet on the teeth of a user by use of a dental appliance or any other attachment means.

FIG. 3 is a diagram of an exemplary headband adapted to position the coil (and related components) external the user's mouth and proximate the magnet attached to a user's teeth.

FIG. 4 is a diagram of an exemplary helmet adapted to position the coil (and related components) external the user's mouth and proximate the magnet attached to a user's teeth.

FIG. 5 is a flowchart describing a method of operation of a tooth microphone in accordance with features and aspects hereof.

### DETAILED DESCRIPTION OF THE DRAWINGS

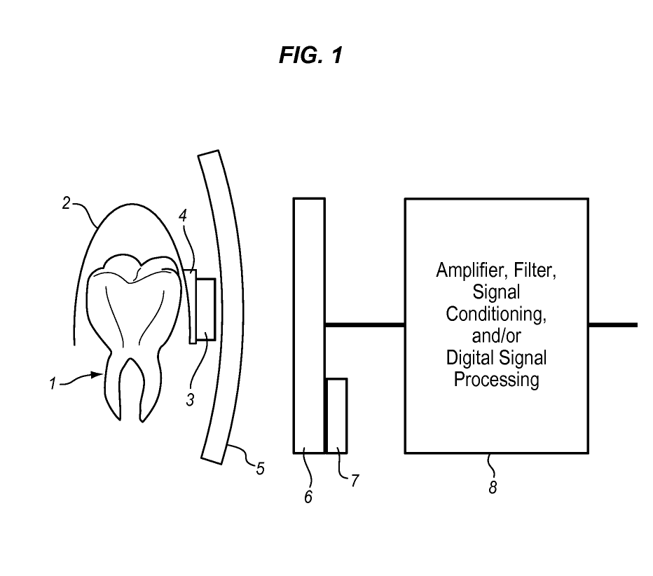

FIG. 1 is a diagram of an exemplary tooth microphone in accordance with features and aspects hereof. A permanent magnet 3 affixed or attached to a dental appliance 2 utilizing adhesive 4 or any suitable means for fixedly attaching magnet 3 to dental appliance 2. Dental appliance 2 may be, for example, a dental splint or wire structure apparatus for removably attaching to one or more teeth 1 of the user. Thus, permanent magnet 3 is attached to 1 of the user inside the user's mouth. Those of ordinary skill in the art will also recognize that permanent magnet 3 may also be fixedly attached directly to teeth 1 utilizing appropriate adhesives where the size of the magnet is small enough to be non-intrusive to the user's speech and other use of the speaker's teeth and mouth. Still further, those of ordinary skill in the art will readily recognize that permanent magnet 3 may represent one or more such permanent magnets arranged horizontally or vertically side by side, or stacked one atop another. In addition, each magnet may be of any suitable size though preferably small enough to avoid interfering with the user's speech or other use of the teeth.

The permanent magnet 3 is a fixedly attached to teeth 1 of the user such that the magnet 3 vibrates synchronously together with the user's teeth 1 or jaw during production of speech or other sounds by the user. As discussed further herein below, a coil and associated active electronic circuits external to the user's mouth may sense the change in magnetic flux caused by a vibrations of the permanent magnet 3 in proportion to sounds or speech produced by the user. As compared to prior techniques, no active electronic circuits or power sources are required within the user's mouth. Only a permanent magnet material and associated physical attachment apparatus or means need be placed within the user's mouth. Therefore, wires that may impede user's speech and/or power sources that may further impede user speech and also present health issues are eliminated in the tooth microphone in accordance with features and aspects hereof.

Preferably the permanent magnet is made from rare earth compounds such as neodymium-iron-boron or other suitable materials possessing permanent magnetic properties. Magnets having a diameter of approximately 3/16 in. to ¼ in. comprising neodymium-iron-boron rare earth materials have been found useful for generating sufficient magnetic flux changes responsive to vibrations of the user's tooth and jaw in proportion to sounds produced by the user or speaker.

Element 5 represents a user's cheek tissue and thus to the left side of cheek 5 is the inside of the user's mouth (including teeth 1 and magnet 3.). To the right side of cheek 5 is coil 6 comprising an electrically conductive material such as copper wire. Coil 6 is positioned external to the user's mouth (e.g., to the right side of cheek 5 in FIG. 1) and generates an electrical current (electrical signal) responsive to changes in magnetic flux caused by vibrations of permanent magnet 3 vibrating synchronously with the user's teeth 1 and jaw responsive to sounds (e.g., speech) produced by the user. The electrical signal produced by coil 6 may be sensed and processed by circuit 8. Circuit 8 may comprise any of several well known electrical components including, for example, a battery or other suitable power source, filtration components to filter desired from undesired signals, other signal conditioning and processing features, and amplification components to amplify the electrical signal produced by coil 6. The amplification, filtration, and signal conditioning and processing features of circuit 8 may be performed by any suitable analog and/or digital signal processing circuits and techniques as well known to those of ordinary skill in the art. By way of example, the electrical signal received from coil 6 may be applied to a band pass filter to pass only the range of frequencies typically associated with human speech. For example, the range of approximately 200 Hz through 10,000 Hz is more than sufficient to cover a typical range of human speech. Thus, circuit 8 may include band pass filtration elements to pass only this typical range of human speech through for further amplification, conditioning, processing etc. In particular, sampling of signals from the coil 6 by circuit 8 during non-speaking times may establish a baseline noise level that may be subtracted from the signals received during speech. This noise-canceling filtration technique (generally known to those skilled in the art) helps isolate the desired signals from the coil that represent user speech or utterances.

Optionally, accelerometer 7 may be attached to coil 6 to produce a signal representative of physical vibrations of coil 6 responsive to movement of the user and/or background noise signals of sufficient amplitude to vibrate coil 6. In extremely loud background noise environments or in environments where the user's vibrations may be extreme, vibration of coil 6 may itself produce sensed changes in the magnetic flux and corresponding electrical currents sensed by circuit 8. Vibrations of coil 6 due to such loud, ambient, background noise or high vibration environments may be improperly sensed as noise or sounds generated by the user. Hence, incorporation of accelerometer 7 adapted to sense such a physical vibrations of coil 6 may be helpful to reduce or eliminate such background noise signals to help improve the quality of the speech sensed through vibration of the permanent magnet 3. The signal produced by accelerometer 7 may be sensed by circuit 8 and subtracted from the electrical signal produced by coil 6 representing magnetic flux changes. Thus, the electrical signal produced by magnetic flux changes due to unwanted vibration of coil 6 may be subtracted from the portion of the electrical signals generated by coil 6 responsive to vibrations of permanent magnet 3 caused by the user and other background noise.

Precise placement and design of the coil 6 and the magnet 3 can also impact the amplitude and quality of the signals generated by the coil and hence the quality of the speech signals reproduced by circuit 8. Any of numerous designs may be employed to design the coil 6 (number of windings, diameter of the windings, etc.) and to optimally orient the magnet 3 inside the mouth relative to the coil 6 outside the mouth. A simple calibration process may be used where the user moves the coil 6 to optimize signal strength and quality. Such techniques are well known to those of ordinary skill in the art such as used in speech recognition computer programs.

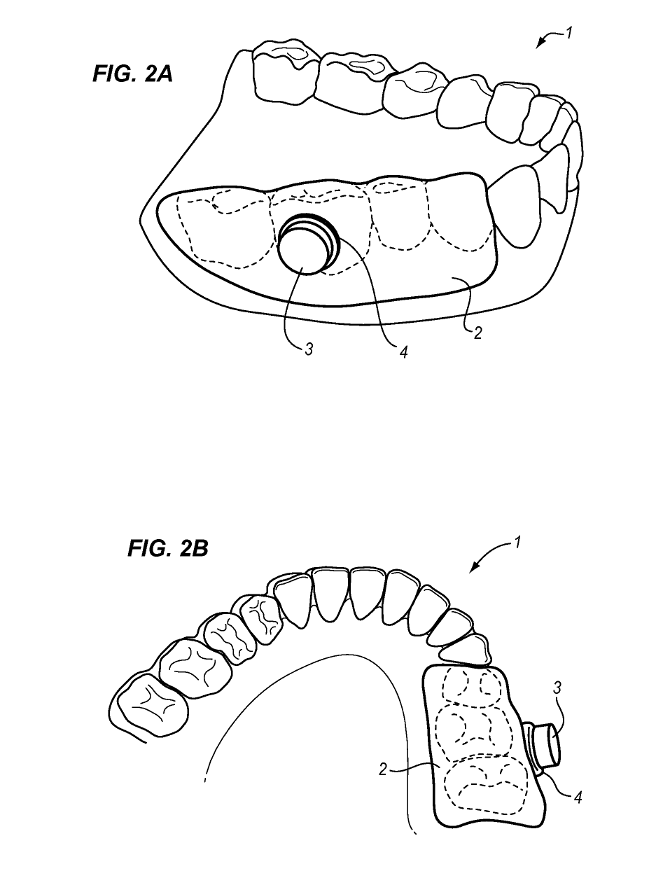

FIG. 2 is a diagram providing some additional details in two views of the teeth 1 of the user's lower jaw. Dental appliance 2 is shown transparently in outline form as a dental appliance produced through standard, well known dental appliance manufacturing procedures. For example, an impression of a user's teeth may be created using plaster or other materials. Vacuum forming devices may then be used to create a tight fitting acrylic resin dental appliance using the plaster copy of the wearer's teeth. Such devices are often referred to as a dental splint and when properly made will snap tightly over the user's teeth and can nonetheless be easily removed. Other well known techniques may be employed to create dental appliances such as wire frame structures adapted to couple tightly to user's teeth 1. Permanent magnet 3 may then be permanently attached to dental appliance 2 using suitable adhesives or any other suitable means for attaching magnet 3 to dental appliance 2. In addition, as noted above, permanent magnet 3 may, in appropriate circumstances, be permanently attached directly to the user's teeth 1 by suitable adhesives or any other suitable attachment means. When permanent magnet 3 is small enough to not impede the user's speech and other functions of the user's mouth and teeth, permanent magnet 3 may be permanently affixed directly to the user's teeth 1. Those of ordinary skill in the art will readily recognize any of several equivalent structures and techniques for attaching a permanent magnet 3 to the user's teeth 1 such that permanent magnet 3 vibrates synchronously with teeth 1 of the user and the associated jaw bone structure. Thus, permanent magnet 3 will vibrate in a manner substantially proportional to the frequencies generated by the user's speech.

Where multiple magnets 3 are utilized within the user's mouth, the magnetic magnets may be positioned spread out vertically, horizontally, or in both directions within the user's mouth attached to the user's teeth 1. In addition, the size of the individual magnets may vary in accordance with the particular user's mouth and teeth.

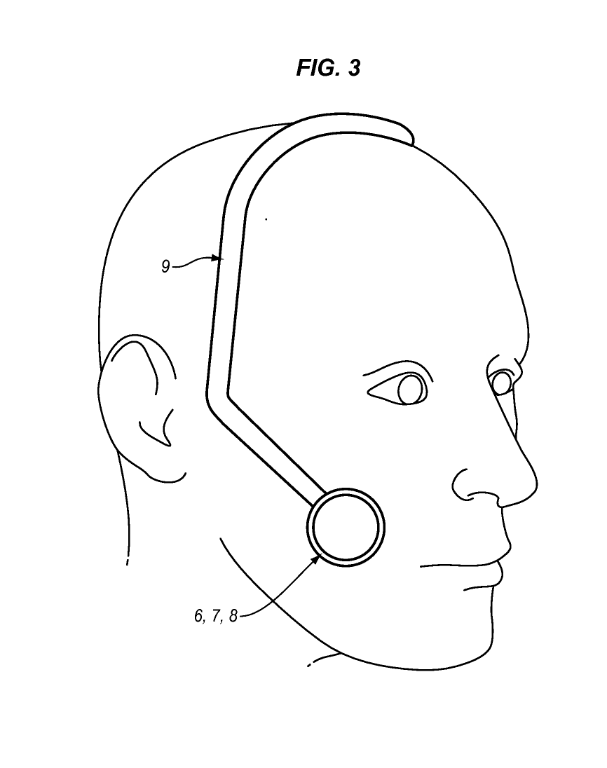

FIG. 3 is a diagram of an exemplary headband 9 adapted to position coil 6 and associated accelerometer 7 (and optionally circuit 8) proximate the permanent magnet positioned within the user's mouth. Headband 9 may be made of any suitable material and adapted appropriately for the size of the user's head. Such headband structures are well known to those of ordinary skill in the art and need not be further detailed herein. Circuit 8 need not be proximate the magnet. Rather, circuit 8 may be positioned elsewhere on headband 9 in any convenient location. Accelerometer 7 preferably is positioned fixedly attached to coil 6 and thus also positioned proximate the permanent magnet within the user's mouth. Signals from coil 6 and accelerometer 7 may be routed through the appropriate wiring to the desired physical location of circuit 8 for appropriate conditioning and processing.

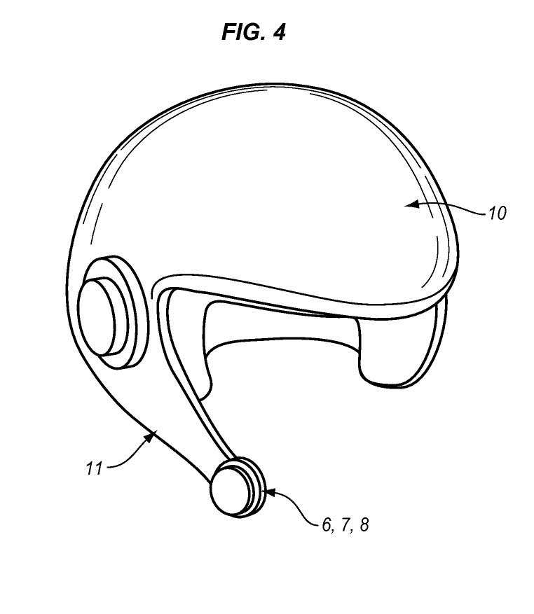

FIG. 4 is a diagram of an exemplary helmet 10 adapted to be placed on a user's head and incorporating an extended arm useful for positioning coil 6 proximate the permanent magnet within the user's mouth. As noted above with regard to FIG. 3, accelerometer 7 is fixedly attached to coil 6 however circuit 8 may be positioned in any suitable, desired location of an extended arm or within helmet 10. Those of ordinary skill in the art will readily recognize numerous useful designs for helmet 10 applicable to the tooth microphone hereof.

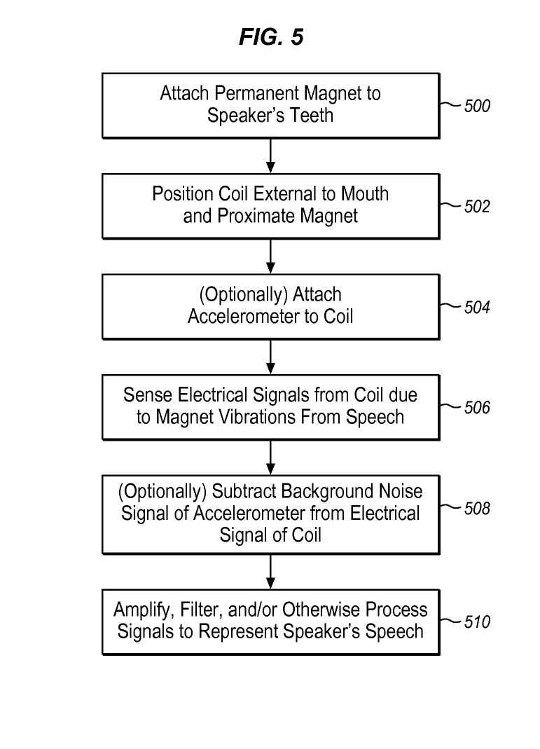

FIG. 5 is a flowchart describing an exemplary method in accordance with features and aspects hereof to provide and operate a tooth microphone. Element 500 is first operable to attach a permanent magnet to the speaker's teeth. As noted above, such attachment may be by any suitable means including, for example, a dental appliance such as a dental splint adapted to removably attach to the user's teeth and having a permanent magnet fixedly attached thereto. Any of numerous equivalent dental appliance structures may be utilized to removably attach the permanent magnet to the user's teeth. In addition, as also noted above, in appropriate circumstances the permanent magnets may be fixedly attached directly to the user's teeth by use of suitable adhesive. Element 502 is next operable to position a coil (e.g., coil of copper wire or other suitable electrically conductive material) external to the user's mouth and proximate the permanent magnet. The coil is preferably positioned with sufficiently rigid structures and materials to reduce the potential for extraneous vibrations from ambient background noise or environments in which the user undergoes substantial vibration. Thus, vibrations of the permanent magnet responsive to user utterances are preferably the only vibration sensed by the coil. As noted above, the coil may be positioned by use of a headband or helmet structure or any other suitable structure to appropriately position the coil. Element 504 next represents the optional attachment of an accelerometer to the coil. As noted above, in environments having significant vibration or notably loud background noise that may also vibrate the coil, an accelerometer may be attached to the coil to sense the physical vibration of the coil and generate a signal proportional thereto. This signal may then be sensed by the signal processing circuit to compensate for the loud background noise or physical vibration in the environment. Element 506 is then operable to utilize the signal processing circuits to sense electrical signals from the coil caused by vibrations of the permanent magnet synchronous with the user's teeth and jaw. Element 508 is then optionally operable to subtract the background noise signal generated by the accelerometer from the electrical signal of the coil. Element 508 thereby subtracts the background noise signal represented by vibration of the coil itself to improve the quality of the voice signal sensed from the electrical signals of the coil. Lastly, element 510 represents all other signal processing useful in improving the quality of the sensed speech of the speaker. The electrical signals generated by the coil may be amplified, filtered, conditioned, and otherwise be processed to improve the quality of the speech signal sensed from the coil. As noted above element 510 may represent operation of any suitable analog and/or digital signal processing components to filter, amplify, condition, and otherwise process the signal generated by coil positioned proximate the permanent magnet within the user's mouth. Those of ordinary skill in the art will readily recognize numerous equivalent and additional method steps that may be employed in configuring, positioning, and operating the tooth microphone in accordance with features and aspects hereof. Such equivalent and additional method steps are eliminated herein for simplicity and brevity of this discussion.

What is claimed is:

1. A microphone comprising:
a permanent magnet attached to a user's tooth wherein the permanent magnet vibrates with the tooth to which it is attached;
a coil positioned external to the user's mouth and proximate the permanent magnet wherein the coil is configured to convert changes of magnetic flux produced by vibrations of the permanent magnet into electrical signals representing sounds produced by the user.

2. The microphone of claim 1
wherein the permanent magnet comprises a rare earth material.

3. The microphone of claim 1
wherein the permanent magnet comprises a Neodymium-Iron-Boron material.

4. The microphone of claim 1
wherein the permanent magnet comprises a plurality of permanent magnets.

5. The microphone of claim 1 further comprising:
a dental splint adapted to receive the permanent magnet and adapted to attach to the user's teeth to thereby attach the permanent magnet to the user's tooth.

6. The microphone of claim 1
wherein the permanent magnet is attached to the user's tooth by adhesive means.

7. The microphone of claim 1
wherein the permanent magnet is attached to the user's tooth by dental appliance means.

8. The microphone of claim 1 further comprising:
signal processing means coupled to the coil for processing the electrical signals generated by the coil to improve the quality of the sensed sounds produced by the user.

9. The microphone of claim 1 further comprising:
a band pass filter coupled to the coil to pass the electrical signals generated by the coil the frequencies of which fall within a pre-defined frequency band.

10. The microphone of claim 9
wherein the pre-defined frequency band is about 200 Hz through 10,000 Hz.

11. The microphone of claim 1 further comprising:
an accelerometer physically coupled to the coil to sense physical vibrations of the coil caused by ambient conditions other than sounds produced by the user wherein the accelerometer generates a background noise signal proportional to the sensed physical vibrations of the coil; and
means for subtracting the background noise signal from the electrical signals generated by the coil.

12. The microphone of claim 1 further comprising:
a headband assembly adapted to position the coil proximate the permanent magnet.

13. The microphone of claim 1 further comprising:
a helmet assembly adapted to position the coil proximate the permanent magnet.

14. A method for sensing sounds generated by a speaker, the method comprising:
attaching a permanent magnet to a tooth of the speaker wherein the permanent magnet is attached so as to vibrate with the speaker's tooth in response to sounds generated by the speaker;
positioning a coil external to the speaker's mouth and proximate the permanent magnet; and
sensing electrical signals generated by the coil responsive to changes in magnetic flux generated by vibrations of the permanent magnet such that the sensed electrical signals are representative of the sounds produced by the speaker.

15. The method of claim 14 further comprising:
filtering the electrical signals generated by the coil to reduce noise signals outside the range of frequencies typical of human speech.

16. The method of claim 14 further comprising:
attaching an accelerometer to the coil to sense physical vibrations of the coil and to generate a background noise signal proportional to the sensed physical vibrations of the coil; and
subtracting the background noise signal from the electrical signals generated by the coil to reduce effects of background noise causing the coil to vibrate.

17. The method of claim 14
wherein the step of attaching further comprises using a dental appliance adapted to retain the permanent magnet and adapted to attach to the teeth of the speaker.

18. The method of claim 14
wherein the step of attaching further comprises using an adhesive to attach the permanent magnet to the teeth of the speaker.
